(19) United States
(12) Patent Application Publication
(10) Pub. No.: US 2022/0289338 A1
(43) Pub. Date: Sep. 15, 2022

(54) GLOW-IN-THE-DARK WATERCRAFT MATTING AND OTHER GLOW-IN-THE-DARK ACCESSORIES

(71) Applicant: Aqua Marine Deck Inc., Buford, GA (US)

(72) Inventor: Thomas Matthews, Braselton, GA (US)

(21) Appl. No.: 17/690,459

(22) Filed: Mar. 9, 2022

Related U.S. Application Data
(60) Provisional application No. 63/159,637, filed on Mar. 11, 2021.

(51) Int. Cl. B63B 17/00; F21V 9/30; B63B 73/00; B63B 32/00; B32B 3/30; B32B 5/18; B32B 7/12

(52) U.S. Cl. CPC B63B 17/00; F21V 9/30; B63B 73/00; B63B 32/00; B32B 3/30; B32B 5/18; B32B 7/12; B32B 2266/08; B32B 2266/0214; B32B 2405/00; B32B 2307/422; B32B 2471/04

(57) ABSTRACT

A watercraft matting is described that includes a bottom surface configured to come into contact with a watercraft surface, a top surface having a plurality of recessed portions disposed between a plurality of protruding portions, where the protruding portions being formed of a non-skid material, and a phosphorescent material positioned within the plurality of recessed portions. The phosphorescent material is adapted to glow-in-the-dark when exposed to an ultraviolet light. The plurality of protruding portions may be formed of a cross-linked-closed-cell (CLCC) foam material.

### CROSS-REFERENCE TO RELATED APPLICATION

The present application claims the benefit of and priority to U.S. Provisional Patent Application No. 63/159,637 filed Mar. 11, 2021, entitled “GLOW-IN-THE-DARK WATERCRAFT FLOORMAT AND OTHER GLOW-IN-THE-DARK ACCESSORIES,” the contents of which being incorporated by reference in their entirety herein.

### BACKGROUND

When exposed to light or other radiation of a relatively short wavelength, phosphorescent materials glow-in-the-dark through absorption of light and remitting at a potentially longer wavelength.

### BRIEF SUMMARY

In a first aspect, a watercraft floormat is described. The watercraft floormat includes a bottom surface configured to come into contact with a watercraft surface; a top surface having a plurality of recessed portions disposed between a plurality of protruding portions, the protruding portions being formed of a non-skid material; and a phosphorescent material positioned within the plurality of recessed portions, the phosphorescent material being adapted to glow-in-the-dark when exposed to an ultraviolet light.

The phosphorescent material may include at least one of: phosphor; zinc sulfide; cadmium sulfide; strontium aluminate; silicate; tritium; phosphoroscope; persistent luminescence; microsphere; fluorescence; chemiluminescence; a diphenyl oxalate and hydrous peroxide mixture; and nitric oxide. The plurality of protruding portions may be formed of a cross-linked-closed-cell (CLCC) foam material. The bottom surface of the watercraft floormat may include an adhesive layer having an adhesive configured to adhere to a surface of a watercraft. The watercraft floormat may be configured for installation on at least one of: an interior floor surface of a watercraft; a swimming platform positioned on a rear of a watercraft; and a seat of a watercraft.

In a second aspect, a method for forming a watercraft floormat is described. The method for forming a watercraft floormat includes providing a bottom surface configured to come into contact with a watercraft surface; providing a top surface having a plurality of recessed portions disposed between a plurality of protruding portions, the protruding portions being formed of a non-skid material; and providing a phosphorescent material positioned within the plurality of recessed portions, the phosphorescent material being adapted to glow-in-the-dark when exposed to an ultraviolet light.

The phosphorescent material may include at least one of: phosphor; zinc sulfide; cadmium sulfide; strontium aluminate; silicate; tritium; phosphoroscope; persistent luminescence; microsphere; fluorescence; chemiluminescence; a diphenyl oxalate and hydrous peroxide mixture; and nitric oxide. The plurality of protruding portions are formed of a cross-linked-closed-cell foam material. The bottom surface of the watercraft floormat may be an adhesive layer comprising an adhesive configured to adhere to a surface of a watercraft. The watercraft floormat may be configured for installation on at least one of: an interior floor surface of a watercraft; a swimming platform positioned on a rear of a watercraft; and a seat of a watercraft.

In a third aspect, a glow-in-the-dark mat is described. The glow-in-the-dark mat includes a bottom surface configured to come into contact with a surface; a top surface having a plurality of recessed portions disposed between a plurality of protruding portions, the protruding portions being formed of a non-skid material; and a phosphorescent material positioned within the plurality of recessed portions, the phosphorescent material being adapted to glow-in-the-dark when exposed to an ultraviolet light. The surface may include at least one of: a watercraft surface; an automobile surface; a portable ice chest surface; a surfboard top surface; and a paddleboard top surface.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1 and 2 are top views of a watercraft floormat showing a glow-in-the-dark property of a phosphorescent material in accordance with various embodiments of the present disclosure.

FIGS. 3 and 4 are top views of the watercraft floormat when in sunlight or similar lighting in accordance with various embodiments of the present disclosure.

FIG. 5 is a perspective view of the watercraft floormat when installed on a floor and/or a seat of a watercraft in accordance with various embodiments of the present disclosure.

FIG. 6 is a perspective view of the watercraft floormat when installed on a swimming platform of a watercraft in accordance with various embodiments of the present disclosure.

FIG. 7 is another perspective view of the watercraft floormat when installed on a floor of a watercraft in accordance with various embodiments of the present disclosure.

FIG. 8 is a perspective view of a glow-in-the-dark mat when installed on a lid or top surface of a portable ice chest in accordance with various embodiments of the present disclosure.

### DETAILED DESCRIPTION

The present disclosure relates to glow-in-the-dark watercraft mats and other glow-in-the-dark accessories. Watercrafts include boats, jet skis, and other recreational vehicles that navigate the ocean, lakes, rivers, and the like. Many watercrafts use leather or faux leather materials that are slick when water or other liquid is applied to the surface. As such, bottom surfaces of a watercraft may include carpet, which has more friction when wet, preventing individuals from slipping. However, carpet is not an optimal material as waterlogged carpet can generate mold and mildew, which leads to bad odors. Accordingly, various embodiments are described for an optimal material that may be implemented in watercrafts and other recreational vehicles.

According to various embodiments, a watercraft matting is described, where the watercraft matting may be implemented in a floormat of a watercraft for example. The watercraft matting may include a bottom surface configured to come into contact with a watercraft surface, and a top surface having various recessed portions disposed between a plurality of protruding portions. The protruding portions may be formed of a non-skid material. A phosphorescent material may be positioned within the recessed portions, where the phosphorescent material is adapted to glow-in-the-dark when exposed to an ultraviolet light (e.g., sunlight, artificial lighting, and the like).

According to various embodiments, the phosphorescent material may include at least one of: phosphor; zinc sulfide; cadmium sulfide; strontium aluminate; silicate; tritium; phosphoroscope; persistent luminescence; microsphere; fluorescence; chemiluminescence; a diphenyl oxalate and hydrous peroxide mixture; and nitric oxide. The protruding portions may be formed of a cross-linked-closed-cell (CLCC) foam material which has non-skid properties when exposes to water. In other words, the CLCC foam material provides a great deal of friction, even when exposed to water, preventing individuals from slipping on wet surfaces in a watercraft. In some embodiments, the bottom surface of the watercraft matting may include an adhesive layer having an adhesive configured to adhere to a surface of a watercraft. The watercraft matting may be configured for installation on at least one of an interior floor surface of a watercraft, a swimming platform positioned on a rear of a watercraft, a dashboard of a watercraft, a steering wheel of a watercraft, a seat of a watercraft, and so forth.

According to various embodiments, a method for forming a watercraft matting is described. The method for forming a watercraft matting may include providing a bottom surface configured to come into contact with a watercraft surface and providing a top surface having various recessed portions disposed between protruding portions. Like the embodiments above, the protruding portions may be formed of a non-skid material. The method may further include providing a phosphorescent material positioned within the plurality of recessed portions, where the phosphorescent material is adapted to glow-in-the-dark when exposed to an ultraviolet light.

Again, the phosphorescent material may include at least one of: phosphor; zinc sulfide; cadmium sulfide; strontium aluminate; silicate; tritium; phosphoroscope; persistent luminescence; microsphere; fluorescence; chemiluminescence; a diphenyl oxalate and hydrous peroxide mixture; and nitric oxide. The protruding portions may be formed of a cross-linked-closed-cell foam material. The bottom surface of the watercraft matting may be an adhesive layer comprising an adhesive configured to adhere to a surface of a watercraft. The watercraft matting may be configured for installation on at least one of an interior floor surface of a watercraft, a swimming platform positioned on a rear of a watercraft, a dashboard of a watercraft, a steering wheel of a watercraft, a seat of a watercraft, and so forth. In further embodiments, the surface may include at least one of an automobile interior or exterior surface, a portable ice chest surface, a surfboard top surface, a paddleboard top surface and so forth.

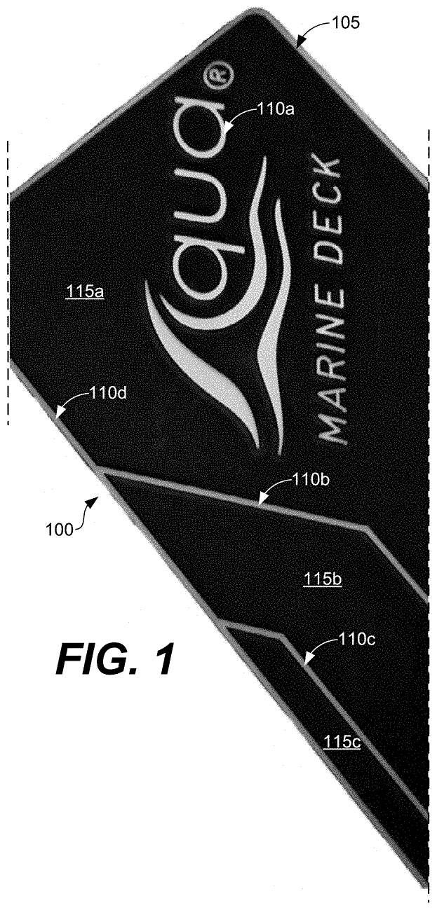

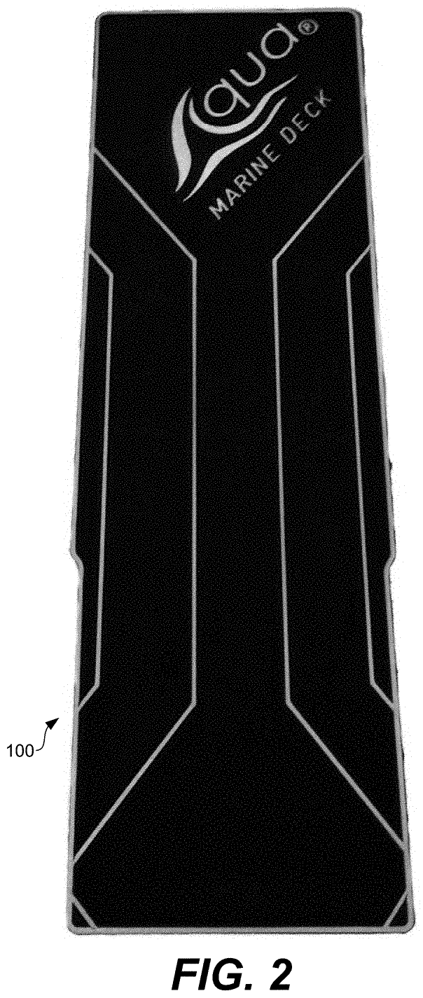

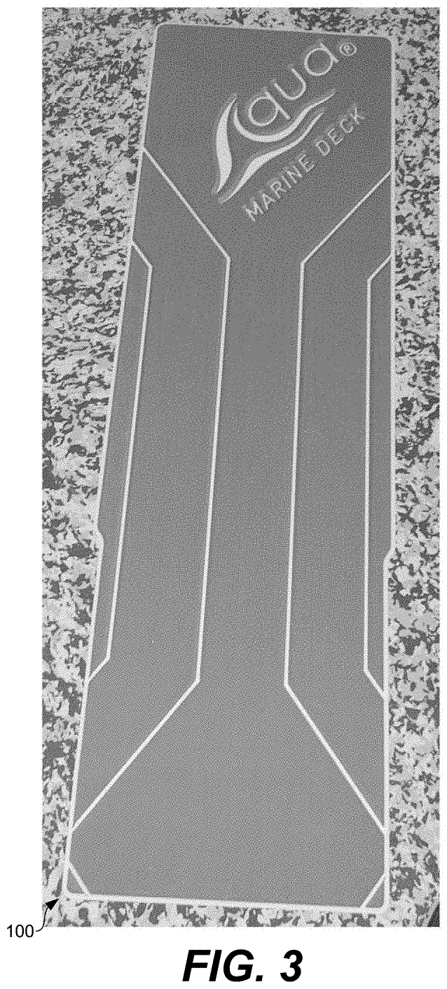

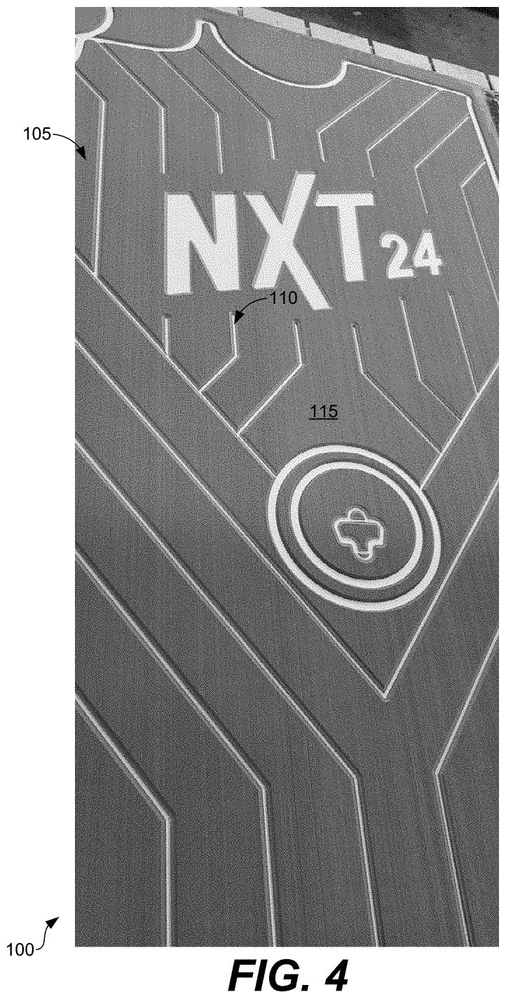

Referring now to the figures, FIGS. 1 and 2 are top views of a watercraft matting 100 having a phosphorescent material that glows-in-the-dark in accordance with various embodiments of the present disclosure. Similarly, FIGS. 3 and 4 are top views of the watercraft matting 100 when in sunlight or similar lighting in accordance with various embodiments of the present disclosure.

Referring collectively to FIGS. 1-4, the watercraft matting 100 includes a bottom surface (not shown) configured to come into contact with a watercraft surface. Further, the watercraft matting 100 includes a top surface 105 having a plurality of recessed portions 110 disposed between a plurality of protruding portions 115. According to various embodiments, the protruding portions 115 may be formed of a non-skid material. Additionally, the arrangement of the recessed portions 110 may be provided such that the watercraft matting 100 has additional non-skid properties. It is understood that the arrangement of the recessed portions 110 may be formed to create various designs, such as logos, linear designs, and so forth. However, the recessed portions 110 also have utility as it increases friction when a foot, animal paw, or other appendage comes into contact with the watercraft matting 100.

Further, the watercraft matting 100 includes a phosphorescent material adapted to glow-in-the-dark. For instance, the phosphorescent material may be adapted to glow-in-the-dark after being exposed to an ultraviolet light, such as sunlight or a black light. As shown in FIGS. 1 and 2, the phosphorescent material may be positioned within the plurality of recessed portions 110. According to various embodiments, the phosphorescent material may include at least one of: phosphor; zinc sulfide; cadmium sulfide; strontium aluminate; silicate; tritium; phosphoroscope; persistent luminescence; microsphere; fluorescence; chemiluminescence; a diphenyl oxalate and hydrous peroxide mixture; and nitric oxide. The plurality of protruding portions 115 may be formed of a cross-linked-closed-cell foam material, as noted above.

In some embodiments, the CLCC foam materials includes “1. foam,” which is a polyolefin elastomer foam comprising polyethylene that is cross linked and closed cell. Examples of other CLCC foams that may be employed include ethylene vinyl acetate foam, ethylene-olefin inter-polymers foam, olefin block copolymers foam, polyolefin foam and cross-linked polyethylene foam. In some embodiments, the CLCC foam material includes dimpled or indented cross-linked-closed-cell foam or other suitable non-skid base material. In various embodiments, the protruding portions 115 may be formed of polyethylene (PE) foam (polyethylene (C₂H₄)n); EVA foam (Ethylene-vinyl acetate (C₂H₄)m, polyethylene-vinyl acetate, or polyethylene-co-vinyl acetate or polyethylene-vinyl acetate copolymer; and a blend of PE and EVA foam.

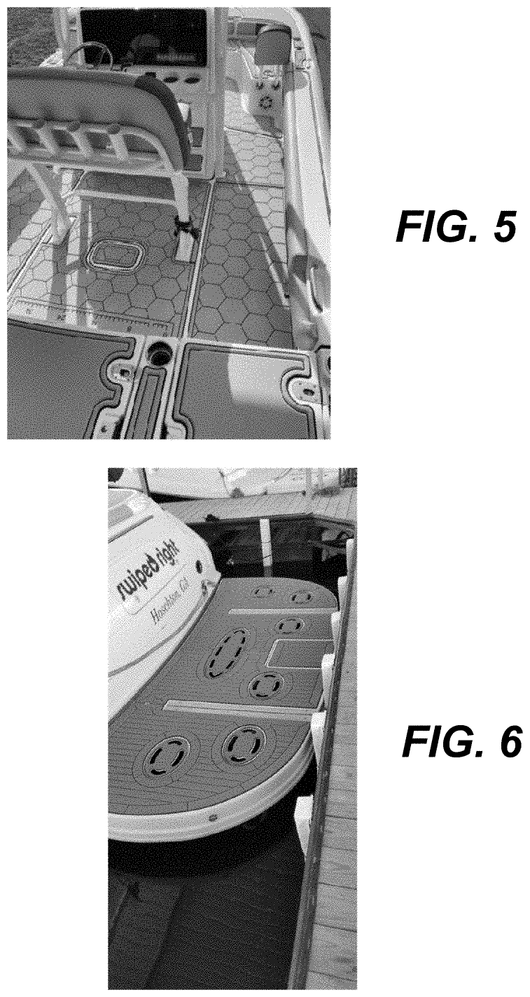

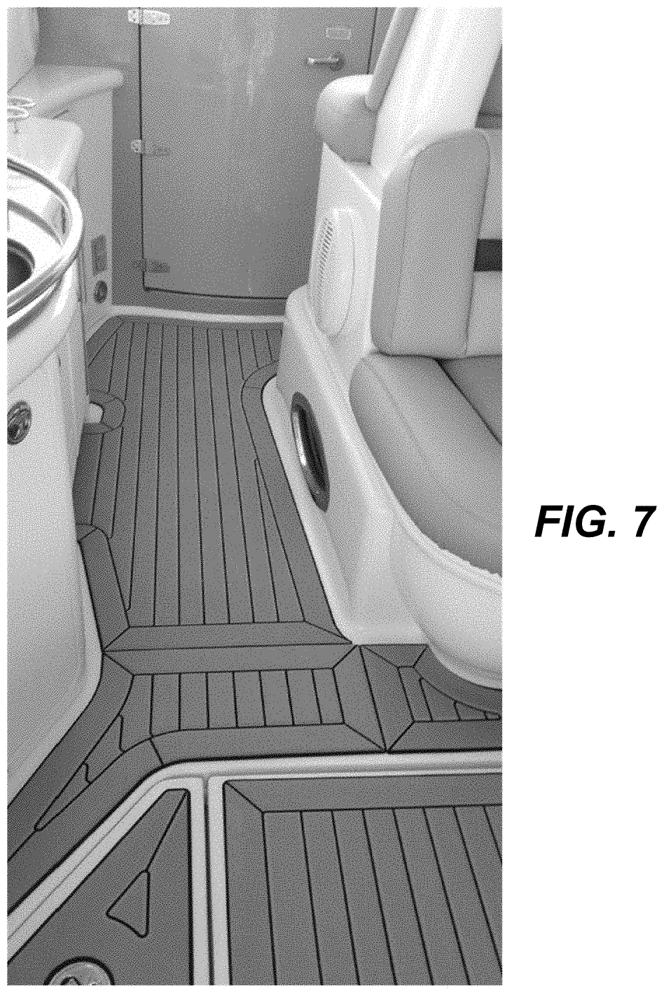

The bottom surface (not shown) of the watercraft matting 100 may include an adhesive layer having an adhesive configured to adhere to a surface of a watercraft, as may be appreciated. As such, the watercraft matting 100 may be configured for installation on at least one of an interior floor surface of a watercraft (e.g., as a watercraft floormat), as shown in FIGS. 5 and 7, a swimming platform positioned on a rear of a watercraft, as shown in FIG. 6; and a seat of a watercraft, as shown in FIG. 5.

In further embodiments, a method for forming the watercraft matting 100 is described. The method for forming the watercraft matting 100 includes providing a bottom surface configured to come into contact with a watercraft surface; providing a top surface 105 having a plurality of recessed portions 110 disposed between a plurality of protruding portions 115, the protruding portions 115 being formed of a non-skid material; and providing a phosphorescent material positioned within the plurality of recessed portions 110, the phosphorescent material being adapted to glow-in-the-dark when exposed to an ultraviolet light.

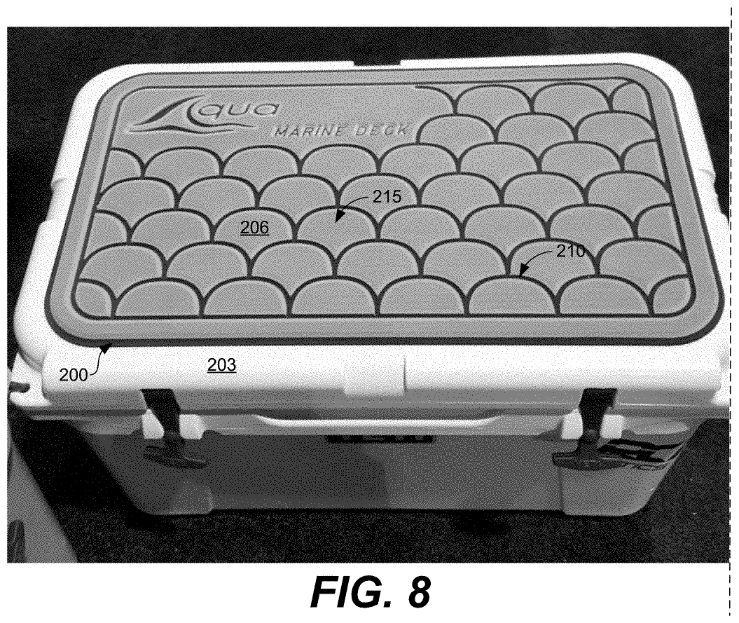

FIG. 8 is a perspective view of a glow-in-the-dark mat 200 when installed on a lid or top surface of another accessory, such as a portable ice chest 203, in accordance with various embodiments of the present disclosure. The glow-in-the-dark mat 200 includes a bottom surface configured to come into contact with a surface of the portable ice chest 203, and a top surface 206 having a plurality of recessed portions 210 disposed between a plurality of protruding portions 215. The protruding portions 215 may be formed of a non-skid material, as described in the embodiments above. Similarly, a phosphorescent material, as described above, may be positioned within the plurality of recessed portions 210. The phosphorescent material may be adapted to glow-in-the-dark when exposed to an ultraviolet light, such as sunlight, artificial lighting, and the like. The recessed portion 210 and the protruding portions 215 are together arranged for form a fish-scale pattern, but other patterns may be employed. The surface in FIG. 8 is shown as a portable ice chest 200, but may also include a watercraft surface, an automobile surface, a surfboard top surface, a paddleboard top surface, and so forth.

In various embodiments, a method for forming a watercraft matting 100 (e.g., a watercraft floormat) is described. The method for forming a watercraft matting 100 includes providing a bottom surface configured to come into contact with a watercraft surface, providing a top surface having a plurality of recessed portions 110 disposed between a plurality of protruding portions 115, the protruding portions 115 being formed of a non-skid material; and providing a phosphorescent material within the plurality of recessed portions 110, the phosphorescent material being adapted to glow-in-the-dark when exposed to an ultraviolet light. The phosphorescent material may be adapted to provide various glow-in-the-dark colors, such as green, yellow, pink, purple, and so on.

The phosphorescent material may include at least one of: phosphor; zinc sulfide; cadmium sulfide; strontium aluminate; silicate; tritium; phosphoroscope; persistent luminescence; microsphere; fluorescence; chemiluminescence; a diphenyl oxalate and hydrous peroxide mixture; and nitric oxide. The plurality of protruding portions are formed of a cross-linked-closed-cell foam material. The bottom surface of the watercraft matting 100 may be an adhesive layer comprising an adhesive configured to adhere to a surface of a watercraft. The watercraft matting 100 may be configured for installation on at least one of an interior floor surface of a watercraft; a swimming platform positioned on a rear of a watercraft; and a seat of a watercraft.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the claims. The terms “first,” “second,” etc. are used only as labels, rather than a limitation for a number of the objects.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A watercraft matting, comprising:
a bottom surface configured to come into contact with a watercraft surface;
a top surface having a plurality of recessed portions disposed between a plurality of protruding portions, the protruding portions being formed of a non-skid material; and
a phosphorescent material positioned within the plurality of recessed portions, the phosphorescent material being adapted to glow-in-the-dark when exposed to an ultraviolet light.

2. The watercraft matting of claim 1, wherein the phosphorescent material comprises at least one of: phosphor; zinc sulfide; cadmium sulfide; strontium aluminate; silicate; tritium; phosphoroscope; persistent luminescence; microsphere; fluorescence; chemiluminescence; a diphenyl oxalate and hydrous peroxide mixture; and nitric oxide.

3. The watercraft matting of claim 1, wherein the plurality of protruding portions are formed of a cross-linked-closed-cell (CLCC) foam material.

4. The watercraft matting of claim 1, wherein the bottom surface of the watercraft matting is an adhesive layer comprising an adhesive configured to adhere to a surface of a watercraft.

5. The watercraft matting of claim 1, wherein the watercraft matting is configured for installation on at least one of: an interior floor surface of a watercraft; a swimming platform positioned on a rear of a watercraft; and a seat of a watercraft.

6. The watercraft matting of claim 1, wherein the watercraft matting is a watercraft floormat configured for installation on at least one of an interior floor surface of a watercraft; a swimming platform positioned on a rear of a watercraft; and a seat of a watercraft.

7. A method for forming a watercraft matting, comprising:
providing a bottom surface configured to come into contact with a watercraft surface;
providing a top surface having a plurality of recessed portions disposed between a plurality of protruding portions, the protruding portions being formed of a non-skid material; and
providing a phosphorescent material positioned within the plurality of recessed portions, the phosphorescent material being adapted to glow-in-the-dark when exposed to an ultraviolet light.

8. The method for forming the watercraft matting of claim 7, wherein the phosphorescent material comprises at least one of: phosphor; zinc sulfide; cadmium sulfide; strontium aluminate; silicate; tritium; phosphoroscope; persistent luminescence; microsphere; fluorescence; chemiluminescence; a diphenyl oxalate and hydrous peroxide mixture; and nitric oxide.

9. The method for forming the watercraft matting of claim 7, wherein the plurality of protruding portions are formed of a cross-linked-closed-cell (CLCC) foam material.

10. The method for forming the watercraft matting of claim 7, wherein the bottom surface of the watercraft matting is an adhesive layer comprising an adhesive configured to adhere to a surface of a watercraft.

11. The method for forming the watercraft matting of claim 7, wherein the watercraft matting is configured for installation on at least one of: an interior floor surface of a watercraft; a swimming platform positioned on a rear of a watercraft; and a seat of a watercraft.

12. The method for forming the watercraft floormat of claim 7, wherein the watercraft matting is a watercraft floormat configured for installation on at least one of: an interior floor surface of a watercraft; a swimming platform positioned on a rear of a watercraft; and a seat of a watercraft.

13. A glow-in-the-dark mat accessory, comprising:
an accessory;
a bottom surface configured to come into contact with a surface of the accessory;
a top surface having a plurality of recessed portions disposed between a plurality of protruding portions, the protruding portions being formed of a non-skid material; and
a phosphorescent material positioned within the plurality of recessed portions, the phosphorescent material being adapted to glow-in-the-dark when exposed to an ultraviolet light.

14. The glow-in-the-dark mat of claim 13, wherein the plurality of protruding portions are formed of a cross-linked-closed-cell (CLCC) foam material.

15. The glow-in-the-dark mat of claim 14, wherein the protruding portions comprise at least one of: polyethylene (PE) foam (polyethylene (C₂H₄)n); EVA foam (Ethylene-vinyl acetate (C₂H₄)m, polyethylene-vinyl acetate, or polyethylene-co-vinyl acetate or polyethylene-vinyl acetate copolymer; and a blend of PE and EVA foam.

16. The glow-in-the-dark mat of claim 13, wherein the accessory is a watercraft and the surface of the accessory is a watercraft surface.

17. The glow-in-the-dark mat of claim 13, wherein the accessory is a portable ice chest and the surface of the accessory is a portable ice chest surface.

18. The glow-in-the-dark mat of claim 13, wherein the accessory is a surfboard, and the surface of the accessory is a surfboard top surface.

19. The glow-in-the-dark mat of claim 13, wherein the accessory is a paddle board, and the surface of the accessory is a paddleboard top surface.
